(19) United States
(12) Patent Application Publication
(10) Pub. No.: US 2006/0162299 A1
(43) Pub. Date: Jul. 27, 2006

(54) Separation apparatus

(76) Inventor: John Herbert North, Norwich (GB)

Correspondence Address: BARNES & THORNBURG, LLP, P.O. BOX 2786, CHICAGO, IL, 60690-2786, US

(21) Appl. No.: 10/523,068

(22) PCT Filed: Sep. 13, 2003
(86) PCT No.: PCT/GB03/04068

§ 371 Date: Aug. 2, 2005

(30) Foreign Application Priority Data
Sep. 17, 2002 (GB) 0221512.7

(51) Int. Cl. B01D 45/12

(52) U.S. Cl. 55/345

(57) ABSTRACT

A cyclonic separation apparatus is described comprising a cylindrical vortex-starting chamber and frusto-conical cyclonic separation chamber. The separation chamber is formed from first and second frusto-conical cyclone regions. The first region has a larger cone-angle than that of the second region for the purpose of reducing the overall axial length of the cyclone separation chamber. A central tubular member extends axially of the cylindrical chamber and comprises a vortex starter. The wider end of the first frusto conical region begins in the region of the downstream end of the central tubular member. The wall of the downstream end of the central tubular member is apertured, and in use the frusto-conical wall of the first region (which is close to the apertured lower end of the central tubular member) forces a progressive reduction in radius on the circulating airstream and therefore a corresponding increase in its rotational velocity in the region of the apertures and just before the airstream enters the second frusto-conical cyclone section. This retains more higher density particulate material in the rotating airstream as it transfers to the second cyclone region than if no such first frusto-conical region is employed, which reduces the chance of higher density material migrating radially inwardly to exit via the apertures in the tubular member instead of remaining in the rotating airstream and moving therewith into the second frusto-conical separation region.

### FIELD OF INVENTION

This invention concerns apparatus using centrifugal force for separating material-based on density.

### BACKGROUND TO THE INVENTION

Whilst conventionally the technique is employed for separating dust and dirt particles from air, the technique is equally applicable to separating one fluid from another such as a liquid from a gas (or air) or one gas from another of different density.

GB Patent Specification 2,367,774 describes a multi-cyclone separation apparatus primarily designed to separate dust and dirt particles from an incoming airstream. One of the cyclone separation zones is contained within chambers 40 and 38, and in FIG. 3 the transition from the cylindrical vortex starting chamber 40 to the frusto-conical chamber 38 is effected by a shallow intermediate frusto-conical section 64, having a different cone angle from that of the chamber 38. The reduction in radius of the helical airflow as it progresses down 38 accelerates the airflow in the cyclone as it continues to rotate around and down this section. After exiting therefrom the more dense material separates therefrom and remains in the dust-collecting chamber within the valve seating 80 above the valve closure 74.

The sudden lack of constraint on the airflow (and particularly on higher density content thereof) immediately below the opening at the lower end of cyclone chamber 38, results in a very efficient separation of the higher density content from the lower density content of the air leaving 38. Cyclonic inversion occurs as the rotating air interacts inter alia with the cup 78, which results in a tightly circulating and upwardly rising helical airflow axially through the lower open end of 38 to travel upwardly and exit through openings 62 in the wall of central vortex-starter tube 58, to pass to the suction producing device 10 (typically a motor driven fan) via a filter 16.

The intermediate section 64 was originally proposed to smooth the transition between the two chambers 40 and 38. However, following experimental work on separators employing such intermediate sections it has become evident that the intermediate frusto-conical transition section has other advantages not hitherto appreciated, and the present invention identifies these other advantages of using an intermediate frusto-conical transition region between these two chambers.

### SUMMARY OF INVENTION

According to one aspect of the present invention in a cyclonic separation apparatus comprising a cylindrical vortex-starting chamber and frusto-conical main cyclonic separation chamber, an intermediate frusto-conical region is provided between the cylindrical vortex starting chamber and the main frusto-conical cyclone chamber for the purpose of reducing the overall axial length of the two chambers.

This enables a cyclonic separating vacuum cleaner to be built of reduced overall height for a given separation efficiency.

The intermediate frusto-conical region has a larger cone angle than that of the main frusto-conical separation chamber.

In particular the use of an intermediate frusto-conical region such as 64 has allowed the overall height of the two chambers (38, 40) making up the second cyclone separation stage of a two-stage cyclone separator, to be reduced.

A similar height reduction could be obtained if the lower end of chamber 40 is flat and perpendicular to the axis of 40 around the entrance to the frusto-conical chamber 38, but the turbulence created by such an arrangement dramatically reduces the separation efficiency of the cyclone system relative to what has been found when using an intermediate frusto-conical region between the cylindrical vortex-starting chamber and the main frusto-conical cyclonic separation chamber.

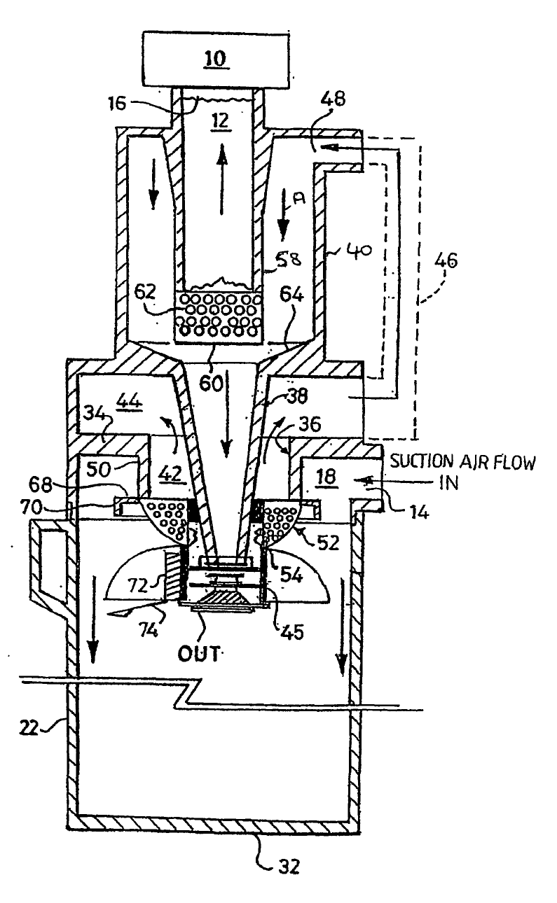

Experiments have also revealed that for a range of cone angles for the intermediate frusto-conical region, the separation efficiency is greater than if the main lower frusto-conical region were to be continued upwardly at the same cone angle, until its diameter corresponds to that of chamber 40 (thereby obviating any intermediate transition of any form) as in FIG. 18 of GB 2,367,774 or in the separator shown in FIGS. 1 and 2 of EP 0042723, or FIG. 5 of GB 2,321,181. Therefore not only is the overall height of the two chambers 38, 40 significantly increased if no intermediate frusto-conical transition section is employed, but the separation efficiency of the unit has been found to be less than that of a unit having an intermediate frusto-conical transition section 64.

According to a second aspect of the present invention in a cyclonic separation apparatus comprising a cylindrical vortex starting chamber and frusto-conical main cyclone separating chamber, the transition between the cylindrical vortex starting chamber and the main frusto-conical cyclone defining separation chamber is located in the region of the downstream end of a central tubular member which extends axially of the vortex starting chamber and is formed by an intermediate frusto-conical region having a larger cone-angle than that of the main cyclone chamber.

With reference to FIG. 3 of GB 2,367,774, by locating the intermediate frusto-conical transition section 64 in the region of the apertured lower end of the central vortex starting tubular housing 58, in use a rapid reduction in radius is forced on the descending helical airstream which is accompanied by a corresponding rapid increase in rotational velocity of the air in the region of the exit apertures 62 and just before it enters the conventional longer cyclone section 38.

This rapid increase in rotational velocity near the apertures 62 in the end of tube 58 has been found to more successfully retain higher density content in the rotating airstream as it transfers to the main cyclone chamber 38, than if no such intermediate frusto-conical section is employed, as in the embodiment of FIG. 18 of GB 2,367,774. This means less chance of higher density material migrating radially inwardly to exit via the apertures 62 instead of remaining in the airstream and travelling therein to the far end of the main cyclone chamber 38 to be separated from the airflow and left in the collection zone, beyond 38.

This improvement has become even more noticeable when the incoming airstream contains moisture and the apparatus is used to separate liquid from the incoming airstream.

In a preferred embodiment the cone angle of the main frusto-conical section of the cyclone separator is in the range 16° to 28°, preferably 20° to 24°, while that of the intermediate frusto-conical section of the separator is in the range 40° to 80°, preferably 64° to 68°.

Two particularly preferred combinations of cone angles are 68° and 20°, and 64° and 24° respectively.

According to a third aspect of the present invention by incorporating an intermediate frusto-conical section between a cylindrical vortex starting chamber and a main frusto-conical cyclone chamber, thereby reducing the overall axial length of the two chambers, the main cyclone chamber can be mounted so as to extend to a lesser axial extent into a main dust collecting bin than would otherwise be the case, without increasing the combined axial length of the two chambers and the bin, thereby effectively increasing the volume of the bin available for storing dust and dirt, for a given combined overall axial length.

Where the apparatus is adapted to separate liquid from air, it is very advantageous to provide the maximum volume for collecting liquid in the bin (in place of dirt and dust particles) and as mentioned above the intermediate frusto-conical region provided for the purpose of increasing this volume is also found to improve the separation of water droplets from the airstream in the second cyclone set up by the cylindrical starter chamber and which thereafter helically rotates axially through the intermediate and main cyclone chamber.

Definition of Cone Angle

If a solid conical member is sliced by a cut line defining a plane containing the central axis of the cone, the cut face of the conical member is an equilateral triangle and the angle at its apex is the cone angle. Where the conical member is truncated to form a frusto-conical member the cone angle of the latter is the cone angle of the conical member from which the frusto-conical member is obtained.

Results of Experiments

Experiments have been undertaken using apparatus employing an intermediate frusto-conical region such as shown in FIG. 3 of GB 2,367,774, in which the internal diameter of the cylindrical chamber 40 is 65 mm, the half-cone angle of the intermediate frusto-conical section is 34°, and that of the longer main section 38 is 10°, the diameter of the smaller open end of the main section 38 is 18 mm, and a gap of the order of 7 to 8 mm is provided between the 18 mm diameter opening and the plate 78 (see FIG. 4 of GB 2,367,774). With an airflow rate of 41-42 litres per second at inlet 14, between 0.5 and 1 gm of Kaolin was found in the final filter from a 200 gm charge of Kaolin introduced into the airflow. Typically 190-191 grams of Kaolin was found in the dust-collecting bin and between 8 and 9 grams in the cyclone system after the experiments.

In the case of 1 litre of water introduced into the airstream at the dirty air inlet such as 14 of FIG. 3 of GB 2,367,774, with a similar air flow in the range 41-42 litres per second, the weight of water not collected in the bin at the end of the experiment (i.e. lost during separation) was of the order of 0.02 gm. This equates to the evaporative loss expected from the mixing of 1 litre of water at room temperature with an airflow of 41-42 litres of air per second at the same temperature.

The invention will now be described by way of example with reference to the accompanying drawing which illustrates a multi-stage separation apparatus embodying the invention.

Reference is made to GB 2,367,774 for a description of the construction and operation of cyclonic separators and for a further description of what is shown in the accompanying drawing.

In the drawing a fan unit 10 draws air and particulate material (which may be liquid droplets) into an inlet 14 where as described in GB 2,367,774 (in relation to FIGS. 1-3 thereof) the airstream is converted into a circulating mass of air and particles around cylindrical vortex starter 50 in the cylindrical region 18.

After traversing the cylindrical bin 22, 32 and returning devoid of the larger particles, the airflow passes through openings 54 in the inverted hemispherical shell 52 to leave via chamber 44 and pipe 46 to the radial inlet 48 at the upper end of a second vortex forming chamber 40. The generally cylindrical vortex starter 58 creates a helically moving airstream which migrates down chamber 40 in the direction of arrow A and the rotational speed is increased as it reaches the frusto-conical transition region 64 between cylindrical chamber 40 and the main frusto-conical separation chamber 38. The starter 58 is hollow, the lower end is solid at 60 and its cylindrical wall is generally also solid but exit openings 62 are formed around the lower end of the wall of 58 near the frusto-conical transition region 64.

The acceleration of the airflow in the vicinity of the lower end of the starter 58 ensures that heavier particles/droplets are kept to the radially outer regions of the circulating air flow and therefore are more likely to transfer in the airstream into 38 rather than leave via openings 62 to pass to the fan 10.

In case any particles do pass into the interior 12 of 58, a filter 16 is provided just upstream of the fan 10.

Most of the particles remaining in the circulating airstream tend to migrate into the main frusto-conical separator 38 where they collect at the lower end as the airstream changes direction from where they will be dumped into the bin 22/32 as the valve 45 opens when the fan is turned off.

The cone angle of the frusto conical region 64 is in the range 40° to 80° and that of the main region is in the range 16° to 28°.

1-9. (canceled)

10. A cyclonic separation apparatus comprising a cylindrical vortex-starting chamber and frusto-conical cyclonic separation chamber, wherein the separation chamber is formed from a first frusto-conical region and a second frusto-conical region, the first region has a larger cone angle than that of the second region for the purpose of reducing the overall axial length of the cyclone separation chamber, the cone angle of the first region being in the range 40° to 80° and that of the second region being in the range 16° to 28°, the apparatus further comprising a particle and/or liquid collecting bin downstream of the second separation region, and being arranged to separate dry particulate material or liquid from air and for collecting the particulate material or liquid in the bin.

11. Separation apparatus as claimed in claim 10 further comprising a central tubular member which extends axially of the cylindrical chamber and comprises a vortex starter and the wider end of the first frusto-conical region begins in the region of the upstream end of the central tubular member.

12. Separation apparatus as claimed in claim 11 wherein the wall of the upstream end of the central tubular member is apertured and the frusto-conical wall of the first region, which is close to the apertured lower end of the central tubular member, in use forces a progressive reduction in radius on the circulating airstream and therefore a corresponding increase in its rotational velocity in the region of the apertures and just before the airstream enters the second frusto-conical cyclone section.

13. Separation apparatus as claimed in claim 10 wherein the two cone angles are 68° and 20° respectively.

14. Separation apparatus as claimed in claim 10 wherein the two cone angles are 64° and 24° respectively.

15. Separation apparatus as claimed in claim 10 wherein reduction in overall axial length of the cyclone separation chamber causes the latter to protrude to a lesser extent into the collecting bin than if a single frusto-conical region were employed having the same cone angle as the second region and the same entrance diameter as the cylindrical vortex-starting chamber, thereby increasing the available storage volume of the bin.
